(19) United States
(12) Patent Application Publication
(10) Pub. No.: US 2008/0121192 A1
(43) Pub. Date: May 29, 2008

(54) Cooling apparatus

(76) Inventor: Rain Moy, Las Vegas, NV (US)

Correspondence Address: JAMES RAY & ASSOCIATES, 2640 PITCAIRN ROAD, MONROEVILLE, PA, 15146, US

(21) Appl. No.: 11/982,507

(22) Filed: Nov. 2, 2007

Related U.S. Application Data
(60) Provisional application No. 60/867,236, filed on Nov. 27, 2006.

(51) Int. Cl. A01K 13/00; A01K 27/00

(52) U.S. Cl. 119/850; 119/856

(57) ABSTRACT

A cooling apparatus including a housing manufactured from a first water permeable predetermined material and having a first predetermined size and first predetermined shape. A plurality of crystals are housed within such housing. The crystals are manufactured from a second water permeable predetermined material capable of absorbing a predetermined amount of water and after absorbing such water the crystals release moisture thereby cooling at least one of a user and a user's pet when such at least one of such user and such user's pet are in contact with the cooling apparatus. The crystals further having each of a second predetermined size when dry and a third predetermined size when wet.

### CROSS REFERENCE TO RELATED APPLICATION

This patent application is related to and claims priority from U.S. Provisional Patent Application Ser. No. 60/867,236 filed Nov. 27, 2006.

### FIELD OF THE INVENTION

The present invention relates, in general, to cooling apparatus and, more particularly, this invention relates to cooling apparatus and pet products.

### BACKGROUND OF THE INVENTION

Prior to the conception and development of the present invention, cooling apparatus as are generally well known in the prior art, have been used by humans to provide relief from heat. Never before has the concept of a cooling apparatus or a cold pack been applied to pet care.

### SUMMARY OF THE INVENTION

The present invention provides a cooling apparatus including a housing manufactured from a first water permeable predetermined material and having a first predetermined size and first predetermined shape. There is a plurality of crystals housed within such housing. The crystals are manufactured from a second water permeable predetermined material capable of absorbing a predetermined amount of water. After absorbing such water the crystals release moisture thereby cooling at least one of a user and a user's pet when such at least one of such user and such user's pet are in contact with the cooling apparatus. The crystals further having each of a second predetermined size when dry and a third predetermined size when wet.

### OBJECTS OF THE INVENTION

It is, therefore, one of the primary objects of the present invention to provide a means for keeping pets cool during exposure to extremely warm temperatures.

Another object of the present invention is to provide a soothing and comforting cold compress that can be used by pets to keep them cool during times of play, exercise, rest and rehabilitation.

Still another object of the present invention is to provide a combination harness and cooling device for pets that will keep the pet cool and comfortable during use.

Yet another object of the present invention is to provide a reusable cooling device for pets.

An additional object of the present invention is to provide a cooling device that can be used by humans and animals to relieve various aches and pains.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of a cooling apparatus according to one embodiment of the invention.

FIG. 2 is a partial perspective view of a cooling apparatus according to one embodiment of the invention.

FIG. 3 is a partial perspective view of a cooling apparatus according to one embodiment of the invention.

FIG. 4 is a cross-sectional view taken along the lines II-II of FIG. 3.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

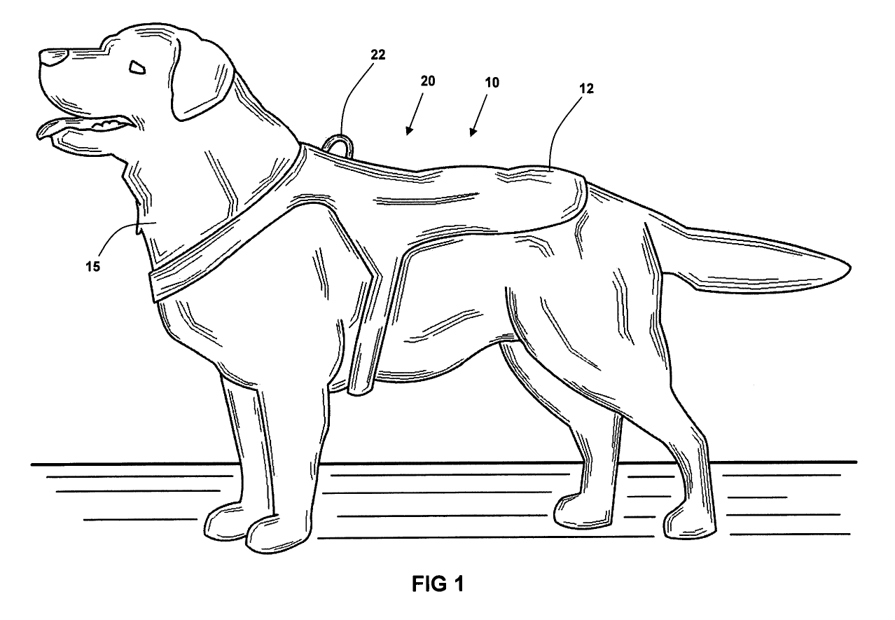

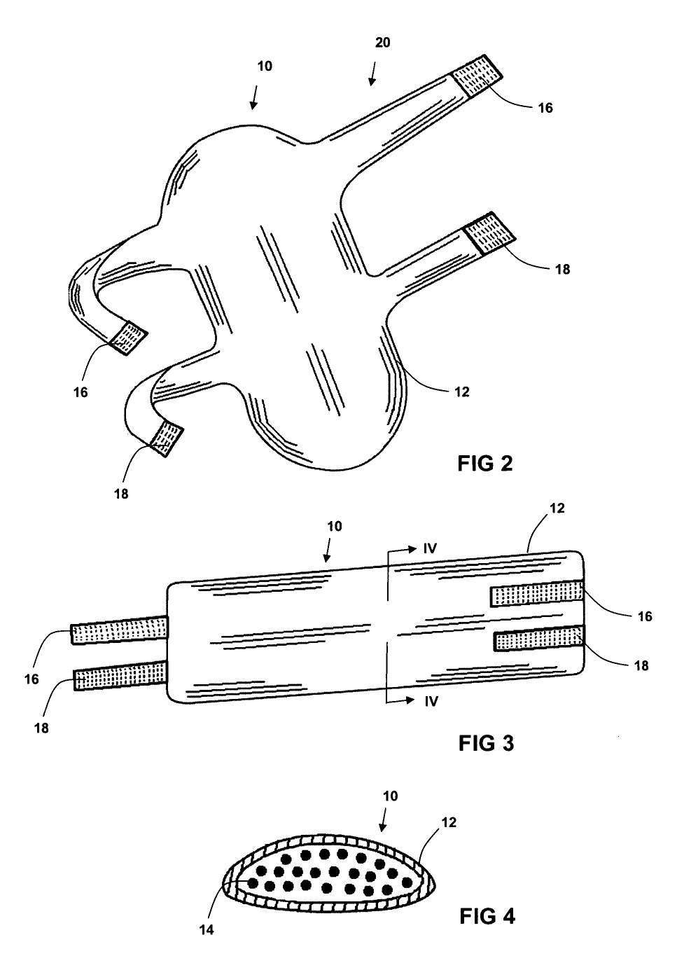

Reference is now made, more particularly, to FIGS. 1-4.

According to a first embodiment of the invention, illustrated in FIGS. 1-4, a cooling apparatus, generally designated 10, is provided.

The cooling apparatus 10 includes a housing 12 manufactured from a first water permeable predetermined material and having a first predetermined size and first predetermined shape.

A plurality of crystals 14 are housed within such housing 12. The crystals 14 are manufactured from a second water permeable predetermined material capable of absorbing a predetermined amount of water and after absorbing such water the crystals 14 release moisture thereby cooling at least one of a user (not shown) and a user's pet, generally designated 15 when at least one of such user and such user's pet 15 are in contact with such cooling apparatus 10. Such crystals 14 further having each of a second predetermined size when dry and a third predetermined size when wet.

In the presently preferred embodiment of the invention, such cooling apparatus 10 has at least one fastening means 16 to secure such cooling apparatus 10 to at least one of such user and such user's pet 15. In the presently preferred embodiment the at least one fastening means 16 is a hook and loop type fastener 18.

In the presently preferred embodiment of the invention, such housing 10 is formed as a pet harness generally designated 20. It is further presently preferred that there is at least one securing means 22 connected operably to such housing 12 for securing a pet leash (not shown) thereto.

It is presently preferred that the first predetermined water permeable material is nylon.

It is presently preferred that the second water permeable material is polyacrylamide.

According to another embodiment of the invention, such third predetermined size is larger than such second predetermined size.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A cooling apparatus comprising;
(a) a housing manufactured from a first water permeable predetermined material and having a first predetermined size and first predetermined shape; and
(b) a plurality of crystals housed within said housing, said crystals manufactured from a second water permeable predetermined material capable of absorbing a predetermined amount of water and after absorbing such water said crystals release moisture thereby cooling at least one of a user and a user's pet when said at least one of such user and such user's pet are in contact with said cooling apparatus, said crystals further having each of a second predetermined size when dry and a third predetermined size when wet.

2. A cooling apparatus, according to claim 1, wherein said cooling device has at least one fastening means to secure said cooling device to at least one of such user and such user's pet.

3. A cooling apparatus, according to claim 2, wherein there is at least one securing means connected operably to said housing for securing a pet leash thereto.

4. A cooling apparatus, according to claim 2, wherein said housing is formed as a pet harness.

5. A cooling apparatus, according to claim 2, wherein said at least one fastening means is a hook and loop type fastener.

6. A cooling apparatus, according to claim 1, wherein said first predetermined water permeable material is nylon.

7. A cooling apparatus, according to claim 1, wherein said third predetermined size is larger than said second predetermined size.

8. A cooling apparatus, according to claim 1, wherein said second water permeable material is polyacrylamide.
